(19) United States
(12) Patent Application Publication
(10) Pub. No.: US 2015/0266175 A1
(43) Pub. Date: Sep. 24, 2015

(54) INSTALLATION TOOL

(71) Applicant: Caterpillar Inc., Peoria, IL (US)

(72) Inventors: Brian P. Billett, Elgin, IL (US); Russell D. Carpenter, Lockport, IL (US); Richard P. Orlovich, Manhattan, IL (US); Frank K. Anthony, Shorewood, IL (US)

(73) Assignee: Caterpillar Inc., Peoria, IL (US)

(21) Appl. No.: 14/221,404

(22) Filed: Mar. 21, 2014

(51) Int. Cl. B25B 27/00

(52) U.S. Cl. CPC B25B 27/0028

(57) ABSTRACT

An installation tool is disclosed. The installation tool includes a mandrel. The mandrel includes a tapered body having a smaller end and a larger end. The smaller end of the mandrel is configured to receive a retention ring thereon. Further, the larger end of the mandrel includes a bore. The bore is configured to receive a portion of a spool therein. The installation tool also includes a gripping member. The gripping member includes an elongate body. The gripping member also includes a plurality of fingers coupled to a first end of the elongate body and extending axially therefrom. The plurality of fingers is configured to slide the retention ring over the tapered body of the mandrel during an installation of the retention ring on the spool. The gripping member further includes an ejection mechanism. The ejection mechanism is configured to disengage the mandrel from the gripping member.

### TECHNICAL FIELD

The patent disclosure relates to an installation tool, and more particularly, to the installation tool for installing a retention ring on a spool.

### BACKGROUND

Retention rings are used in many fields such as, aerospace, automotive, military applications and the like. The retention rings are configured to hold assemblies onto a spool or a shaft. These retention rings are generally provided within grooves formed on the spools, such that a shoulder of the retention ring is configured to retain the assemblies thereon. An installation tool is used to install the retention rings on the spool.

U.S. Pat. No. 6,993,816 discloses a retaining ring installation tool for use in installing retaining rings onto shafts and into bores. The installation tool is formed from a single piece of metal to define a cylindrical, elongated body. A hollow cavity is formed in one end of the body and the wall of the body that defines the cavity is slotted to form a plurality of individual, flexible spring contact arms or fingers which extend forwardly from a rear body portion and which collectively define an insertion end of the tool. The ends of the fingers are enlarged to ensure that contact occurs between the tool and the retaining ring during the installation of the ring onto a shaft or into a bore. The contact arms are bent radially, inwardly or outwardly so that they will contact the retaining ring at all times during installation of the ring.

### SUMMARY OF THE DISCLOSURE

In one aspect of the present disclosure, an installation tool is disclosed. The installation tool includes a mandrel. The mandrel includes a tapered body having a smaller end and a larger end. The smaller end of the mandrel is configured to receive a retention ring thereon. Further, the larger end of the mandrel includes a bore. The bore is configured to receive a portion of a spool therein. The installation tool also includes a gripping member. The gripping member includes an elongate body defining a central axis. The gripping member also includes a plurality of fingers coupled to a first end of the elongate body. The plurality of fingers extend axially from the elongate body. The plurality of fingers is configured to slide the retention ring over the tapered body of the mandrel during an installation of the retention ring on the spool. The gripping member further includes an ejection mechanism provided on the elongate body. The ejection mechanism is configured to disengage the mandrel from the gripping member.

In another aspect, a method for installing a retention ring on a spool is disclosed. The method includes receiving the spool into a bore provided on a larger end of a tapered mandrel. The method also includes placing the retention ring on a smaller end of the tapered mandrel. The method further includes aligning a gripping member with the tapered mandrel. The method includes contacting a plurality of fingers of the gripping member with the retention ring and the tapered mandrel. The method also includes sliding the retention ring over the tapered mandrel. The method further includes positioning the retention ring on the spool. The method includes engaging the tapered mandrel within the plurality of fingers of the gripping member. The method also includes decoupling the tapered mandrel and the gripping member from the spool. The method further includes disengaging the tapered mandrel from the gripping member.

Other features and aspects of this disclosure will be apparent from the following description and the accompanying drawings.

### BRIEF DESCRIPTION OF THE DRAWINGS

FIG. 1 is a side view of an exemplary spool, according to one embodiment of the present disclosure;

FIG. 2 is a perspective view of an installation tool;

FIG. 3 is a cross-sectional view of a mandrel of the installation tool of FIG. 2;

FIGS. 4 and 5 are side views of the spool, gripping member and the mandrel during an installation of a retention ring on the spool;

FIGS. 6 and 7 are perspective views of the installation tool, after the installation of the retention ring on the spool; and

FIG. 8 is a flowchart for a method of installing the retention ring on the spool.

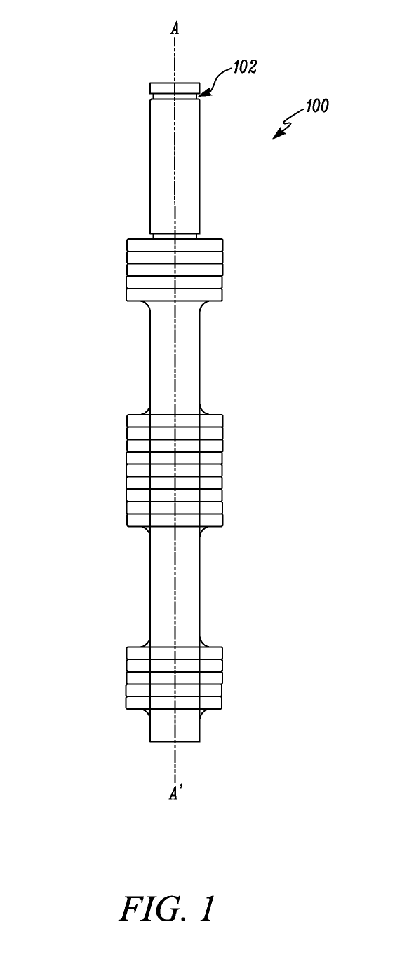

### DETAILED DESCRIPTION

Wherever possible, the same reference numbers will be used throughout the drawings to refer to the same or the like parts. FIG. 1 is a side view of an exemplary spool 100. The spool 100 defines a longitudinal axis A-A′ . As illustrated in the accompanying figure, the spool 100 includes a groove 102 provided near one end of the spool 100.

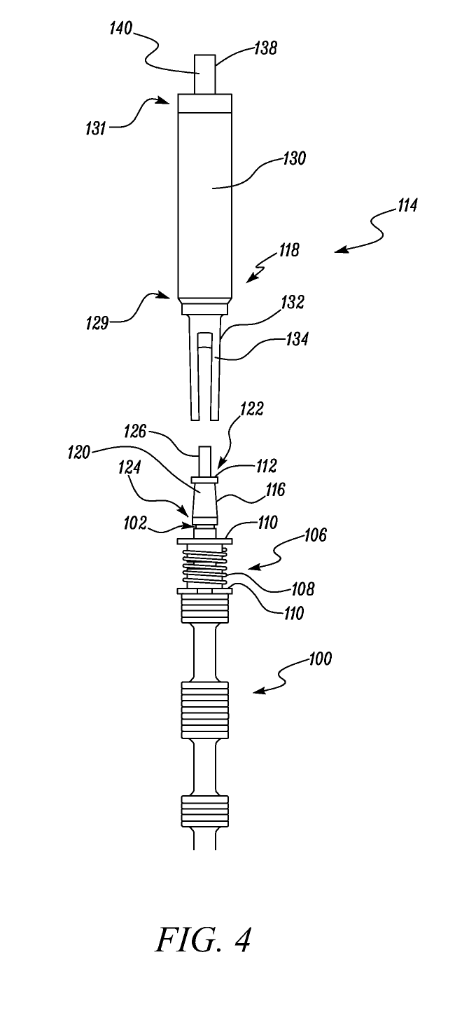

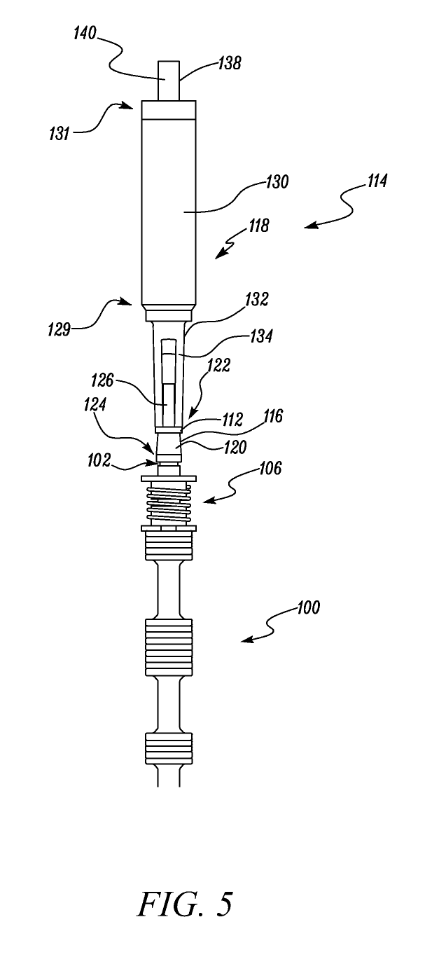

Additionally, a spring assembly 106 (See FIGS. 4 and 5) may be provided on the spool 100. The spring assembly 106 includes a spring member 108 and two flanges 110 positioned at each end of the spring member 108. The spool 100 also includes a retention ring 112 provided on the spool 100. More particularly, the groove 102 of the spool 100 is configured to receive the retention ring 112 therein. When installed, the retention ring 112 is configured to hold the spring assembly 106 on the spool 100. One of ordinary skill in the art will appreciate that the spool 100 shown in accompanying figures and described herein is exemplary and does not limit the scope of the present disclosure. The design of the spool 100 may vary based on the application.

The retention ring 112 may embody a snap ring. In the illustrated embodiment, the retention ring 112 is a spiral snap ring. Alternatively, the retention ring 112 may embody a wire ring, circlips and the like. The retention ring 112 may be made of a metal, for example, high strength steel. Alternatively, the retention ring 112 may be made of a high strength polymer.

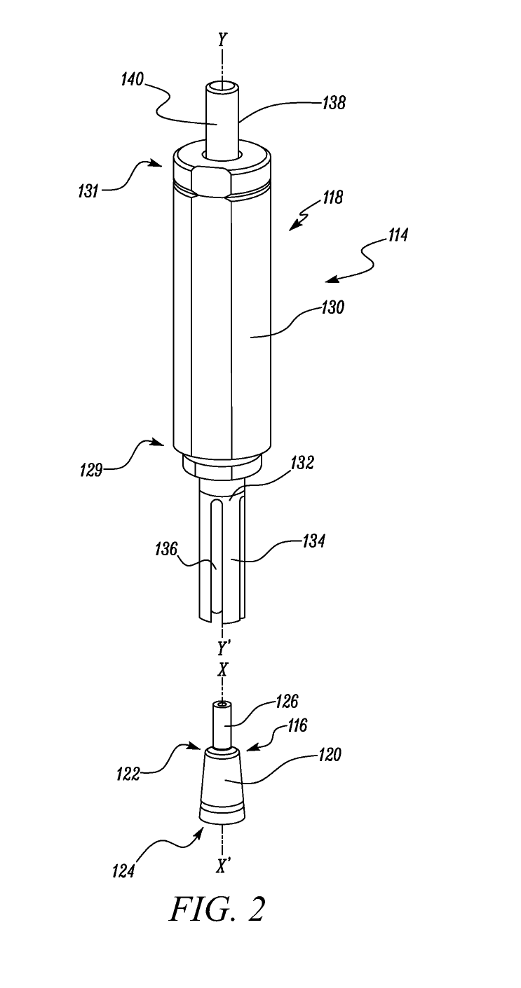

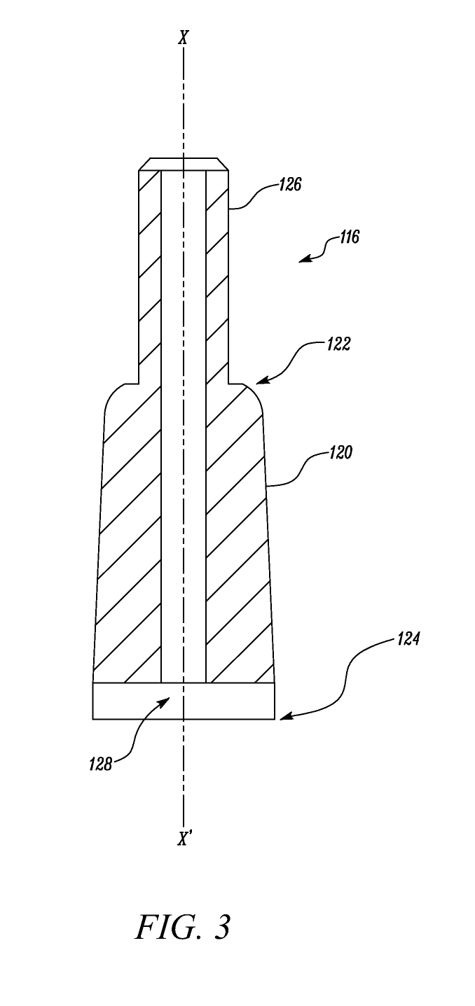

The present disclosure relates to an installation tool 114 for installing the retention ring 112 on the spool 100. FIG. 2 is a perspective view of the installation tool 114, according to one embodiment of the present disclosure. As illustrated, the installation tool 114 has a two piece design. The installation tool 114 includes a mandrel 116 and a gripping member 118. Referring to FIG. 3, the mandrel 116 has a tapered body 120. The mandrel 116 defines a longitudinal axis X-X′. The tapered body 120 of the mandrel 116 allows for an easy sliding of the retention ring 112 thereover, during the installation of the retention ring 112 within the groove 102 of the spool 100. The tapered body 120 includes a smaller end 122 and a larger end 124. Further, the mandrel 116 includes a projection 126 extending from the smaller end 122 of the mandrel 116 along the axis X-X′. The smaller end 122 of the mandrel 116 is configured to receive the retention ring 112 thereon during the installation of the retention ring 112 on the spool 100.

The mandrel 116 also includes a bore 128. The bore 128 is provided at the larger end 124 of the mandrel 116. During the installation of the retention ring 112, the bore 128 is configured to receive a portion of the spool 100 therein. A depth of the bore 128 is so chosen such that during the installation of the retention ring 112 on the spool 100, the mandrel 116 is positioned in front of the groove 102 or partially covering an upper portion of the groove 102 (see FIGS. 4 and 5). More particularly, the bore depth of the bore 128 is provided such that the mandrel 116 does not completely cover the groove 102 of the spool 100 when coupled thereto. The shape and dimensions of the bore 128 is based on that of the portion of the spool 100 being received by the bore 128. For example, a diameter of the bore 128 may be approximately equal to a diameter of the spool 100.

The mandrel 116 is configured to locate a center of the spool 100 for the installation of the retention ring 112 thereon. Details of installing the retention ring 112 on the spool 100 using the installation tool 114 will be explained in connection with FIGS. 3 to 7.

Referring now to FIG. 2, the gripping member 118 of the installation tool 114 includes an elongate body 130 defining an axis Y-Y′. The elongate body 130 has a cylindrical configuration. The elongate body 130 may have a chamfered outer surface. This chamfered outer surface may assist in providing a grip or hold over the gripping member 118 during usage of the installation tool 114.

The elongate body 130 includes a first end 129 and a second end 131. Further, the gripping member 118 includes a plurality of fingers 132 provided in a circumferentially spaced arrangement from each other. In the illustrated embodiment, the gripping member 118 includes four such fingers 132. Each of the fingers 132 has an outer surface 134 and an inner surface 136. The outer surface 134 of the fingers 132 has a flat or planar shape. The inner surface 136 of the finger 132 is shaped to correspond to a contour of the tapered body 120 of the mandrel 116. The fingers 132 are attached to the first end 129 of the elongate body 130, such that the fingers 132 extend longitudinally from the elongate body 130. In the illustrated embodiment, the plurality of fingers 132 is threadably coupled to the first end 129 of the elongate body 130. In another embodiment, the fingers 132 and the elongate body 130 form an integrated unit. Alternatively, the fingers 132 may be welded to the elongate body 130. The fingers 132 may be made of any of a metal or an alloy.

The installation of the retention ring 112 within the groove 102 of the spool 100 will now be explained in detail. Referring to FIG. 4, initially, the mandrel 116 is hand fitted onto the spool 100. The larger end 124 of the mandrel 116 is positioned above or partially covering the groove 102 of the spool 100. The retention ring 112 may be dropped onto or loosely placed on the smaller end 122 of the mandrel 116.

Referring to FIG. 5, the fingers 132 of the gripping member 118 are brought in contact with the retention ring 112 and the tapered body 120 of the mandrel 116. A force is applied on the gripping member 118 in a downward direction, thereby causing the retention ring 112 to slide over the tapered body 120 of the mandrel 116. While sliding over the tapered body 120, a constant area of contact may be maintained between the fingers 132, the retention ring 112 and the mandrel 116. Further, the retention ring 112 may expand in accordance with the contour of the tapered body 120 of the mandrel 116. As the retention ring 112 slides over the larger end 124 of the mandrel 116, the retention ring 112 is configured to retract and fit within the groove 102 of the spool 100.

As discussed earlier, the fingers 132 of the gripping member 118 are configured to slide over the tapered body 120 of the mandrel 116. The inner surface 136 of each of the fingers 132 is thus shaped to cooperate with the tapered body 120 of the mandrel 116. Accordingly, a thickness of the finger 132 may vary along a length of the finger 132.

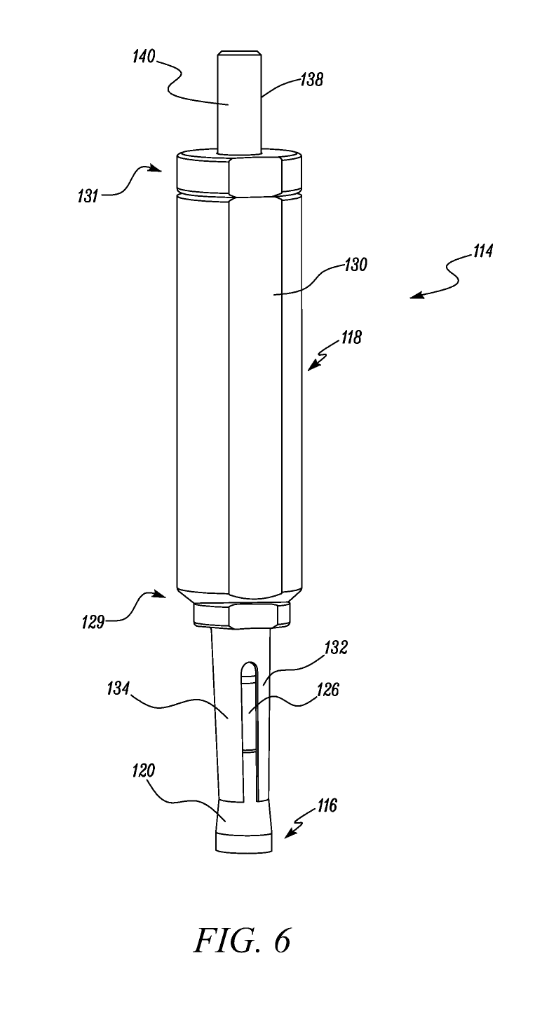

After the retention ring 112 is fitted within the groove 102, the gripping member 118 is pulled away from the spool 100 in an upward direction. As shown in FIG. 6, the spool 100 is disengaged from the mandrel 116. However, the mandrel 116 is firmly gripped within the fingers 132 of the gripping member 118. Accordingly, the installation tool 114 is removed from the spool 100 as a single unit.

The gripping member 118 includes an ejection mechanism 138 in order to disengage the mandrel 116 from the gripping member 118. The ejection mechanism 138 is provided within the elongate body 130 of the gripping member 118. The elongate body 130 includes a through hole, such that the through hole is configured to slidably receive a rod (not shown) therein. The smaller end 122 of the mandrel 116 is configured to contact with a lower end of the rod when the mandrel 116 is gripped within the fingers 132 of the installation tool 114. The elongate body 130 may also include a spring (not shown) provided in association with the rod. The spring is provided at least partially along a length of the rod.

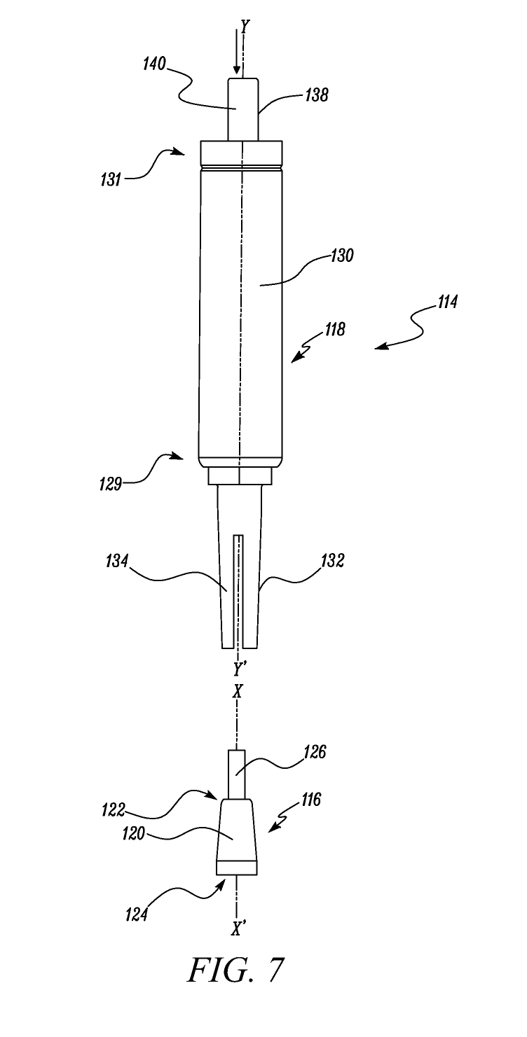

The ejection mechanism 138 includes a button 140 provided at the second end 131 of the elongate body 130. Referring now to FIG. 7, when the button 140 of the ejection mechanism 138 is pressed in a downward direction, the rod is configured to move downwards against a spring force. The rod is configured to contact the mandrel 116 and thereby push the mandrel 116 out of the plurality of fingers 132 of the gripping member 118 in the downward direction in order to release the mandrel 116 from the gripping member 118. The spring force may restore the rod to that of an initial position after the disengagement of the mandrel 116 from the gripping member 118. Alternatively, the ejection mechanism 138 may include any other mechanical arrangement to restore the rod to the unloaded position. It should be noted that the parts of the gripping member 118 and the mandrel 116 of the present disclosure may be made using any metal or polymer known to a person of ordinary skill in the art. Also, the dimensions of the gripping member 118 and the mandrel 116 may also vary based on the dimensions of the spool 100.

It should be noted that the installation tool 114 may be operated manually for smaller dimensions of the spool 100. However, for installation of retention rings 112 within spools 100 having large dimensions, the installation tool 114 may form a part of an automated assembly.

### INDUSTRIAL APPLICABILITY

The present disclosure relates to the installation tool 114 for providing the retention ring 112 on the spool 100. The installation tool 114 may accommodate various sizes of the plurality of fingers 132, based upon the size of the spool 100.

The plurality of fingers 132 is configured to evenly contact the surface of the retention ring 112 through out the installation process. Due to the even contact, a lower amount of force may be required for the installation using the installation tool 114. Further, the lesser force in turn may prevent deformation of the retention ring 112. The installation tool 114 disclosed herein has a light weight and compact design.

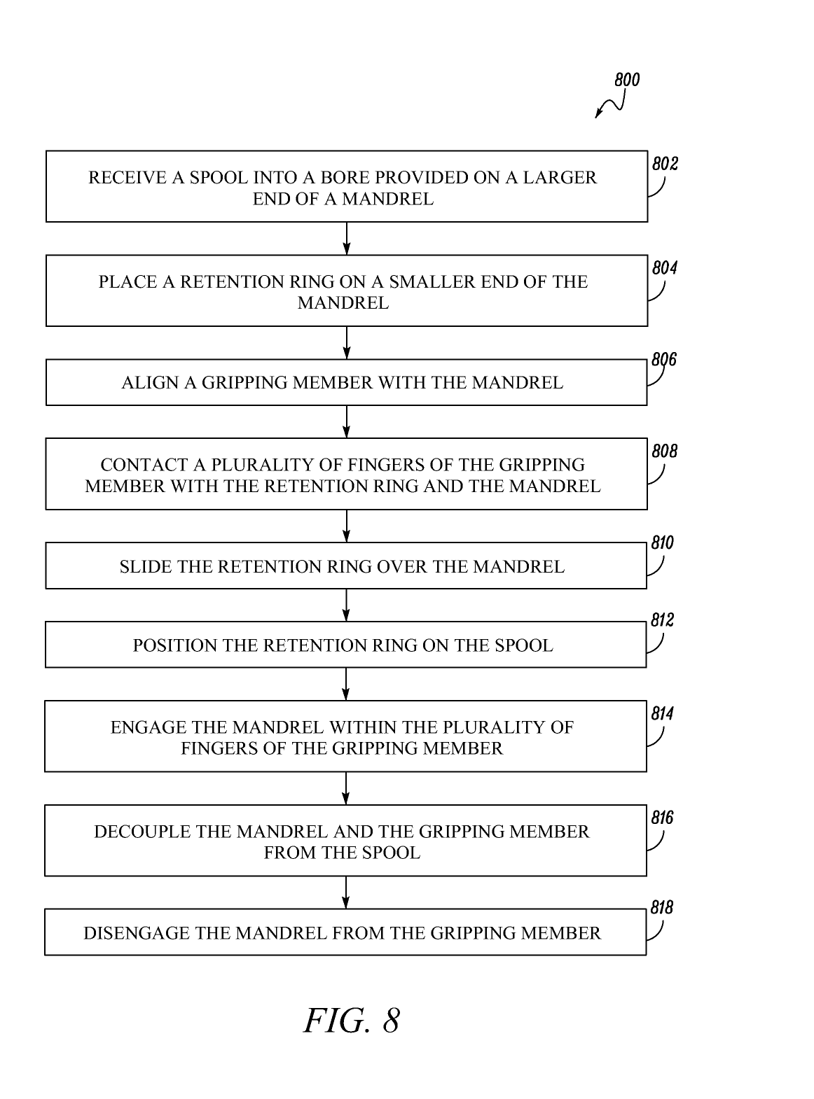

FIG. 8 is a flowchart for a method 800 of installing the retention ring 112 on the spool 100. At step 802, the spool 100 is received into the bore 128 provided on the larger end 124 of the mandrel 116. At step 804, the retention ring 112 is placed on the smaller end 122 of the mandrel 116. At step 806, the gripping member 118 is aligned with the mandrel 116.

At step 808, the fingers 132 of the gripping member 118 are contacted with the retention ring 112 and the tapered body 120 of the mandrel 116. At step 810, the retention ring 112 is slid over the tapered body 120 of the mandrel 116. The force in the downward direction is applied on the gripping member 118, causing the fingers 132 to push the retention ring 112 against the tapered body 120 of the mandrel 116. At step 812, the retention ring 112 is positioned on the spool 100. The retention ring 112 may retract and fit into the groove 102 provided on the spool 100. At step 814, during the installation of the retention ring 112, the mandrel 116 is engaged within the plurality of fingers 132 of the gripping member 118. At step 816, the mandrel 116 and the gripping member 118 are pulled away or decoupled from the spool 100. At step 818, the mandrel 116 is disengaged from the gripping member 118 using the ejection mechanism 138 provided on the gripping member 118.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An installation tool comprising:
a mandrel including a tapered body having a smaller end and a larger end, wherein the smaller end is configured to receive a retention ring thereon, and wherein the larger end includes a bore, the bore configured to receive a portion of a spool therein; and
a gripping member comprising:
an elongate body defining a central axis;
a plurality of fingers coupled to a first end of the elongate body, the plurality of fingers extending axially from the elongate body, wherein the plurality of fingers are configured to slide the retention ring over the tapered body of the mandrel during an installation of the retention ring on the spool; and
an ejection mechanism provided on the elongate body, the ejection mechanism configured to disengage the mandrel from the gripping member.

2. The installation tool of claim 1, wherein the ejection mechanism includes a button provided at a second end of the elongate body.

3. The installation tool of claim 1, wherein the ejection mechanism includes a rod slidably provided within the elongate body, the rod configured to push the mandrel out of the plurality of fingers of the gripping member.

4. The installation tool of claim 1, wherein the ejection mechanism includes a spring provided at least partially along a length of the rod.

5. The installation tool of claim 1, wherein the plurality of fingers are threadably coupled to the elongate body.

6. The installation tool of claim 1, wherein a diameter of the bore is sized based on a diameter of the spool.

7. The installation tool of claim 1, wherein a depth of the bore is such that the mandrel is positioned in front of a groove provided on the spool when the mandrel is coupled to the spool.

8. The installation tool of claim 1, wherein an inner surface of each of the plurality of fingers is shaped to cooperate with the tapered body of the mandrel.

9. The installation tool of claim 1, wherein an outer surface of each of the plurality of fingers is planar.

10. The installation tool of claim 1, wherein each of the plurality of fingers is made of any one of a metal and an alloy.

11. The installation tool of claim 1, wherein each of the plurality of fingers are circumferentially spaced apart from one another.

12. The installation tool of claim 1, wherein the elongate body of the gripping member has a cylindrical configuration.

13. A method for installing a retention ring on a spool, the method comprising:
receiving the spool into a bore provided on a larger end of a tapered mandrel;
placing the retention ring on a smaller end of the tapered mandrel;
aligning a gripping member with the tapered mandrel;
contacting a plurality of fingers of the gripping member with the retention ring and the tapered mandrel;
sliding the retention ring over the tapered mandrel;
positioning the retention ring on the spool;
engaging the tapered mandrel within the plurality of fingers of the gripping member;
decoupling the tapered mandrel and the gripping member from the spool; and
disengaging the tapered mandrel from the gripping member.
